(19) United States
(12) Patent Application Publication
(10) Pub. No.: US 2004/0152409 A1
(43) Pub. Date: Aug. 5, 2004

(54) Automotive air duct

(76) Inventors: Michael A. Mooney, Gansevoort, NY (US); Jeffery D. Parish, Saratoga Springs, NY (US)

Correspondence Address: MICHAEL A. MOONEY, 84 COBBLE HILL DRIVE, GANSEVOORT, NY, 12831, US

(21) Appl. No.: 10/354,826

(22) Filed: Jan. 30, 2003

(51) Int. Cl. B60J 1/20

(52) U.S. Cl. 454/135; 454/131

(57) ABSTRACT

Disclosed herein is a portable automotive air-scooping device configured for the creation of additional airflow into the interior of an automobile. The portable air intake is fastened to the frame of an automobile door with the discharge point facing the inside of the automobile. A removable diverter extension may be inserted into the air discharge point. The device is mounted on a framed automobile door with hook and loop straps. As the automobile is driven the air intake collects air and sends it through the diverter extension a significant amount fresh airflow and volume is created. This additional airflow creates a cooling affect on the occupants of the automotive vehicle.

### CROSS-REFERENCE TO RELATED APPLICATIONS

U.S. Patent documents

| | | | |
|---|---|---|---|
| 5,003,866 | Apr. 2, 1991 | Ricci | 98/2 |
| 4,193,339 | Mar. 18, 1980 | Giles | 98/2 |
| 4,470,341 | Sep. 11, 1984 | Hirukawa | 98/2 |
| 3,606,444 | Sep. 4, 1969 | Allenbaugh | 98/2 |
| 3,401,620 | Sep. 17, 1968 | Armstrong | 98/2 |

### REFERENCE TO MICROFICHE APPENDIX

“Not Applicable”

### STATEMENT REGARDING FEDERALLY SPONSORED RESEARCH OR DEVELOPMENT

“Not Applicable”

### BACKGROUND OF THE INVENTION

This invention is a portable device to provide additional flow of air to a compartment of any automotive vehicle.

Conventionally, fresh air enters most automotive vehicles through a louvered space between the engine compartment door and the windshield. The fresh air then passes through a cowl and duct system to the interior of the vehicle. However, the air that reaches the interior of the vehicle is usually warmer than the outside temperature and does not provide a significant amount of airflow or volume of fresh air to have any type of cooling affect on occupants of the automotive vehicle.

### SUMMARY OF INVENTION

Accordingly, an object of the present invention is to provide additional fresh air at a flow rate and volume sufficient to have a cooling affect on the occupants of the automotive vehicle.

### DESCRIPTION OF THE DRAWINGS

FIG. 1 is a perspective view taken with the subject invention installed on the driver's side front door of an automobile. This view shows the installation on the front door however; this device can be quickly installed on any automobile door with a framed window.

FIG. 2 is a front perspective view of the portable air duct. Location #11 of the device is the air intake shroud. Location 12 is the air discharge port with integral provisions for the connection of the diverter extension. Location #13 shows slots that are used to strap the device to the doorframe. This device will be made of an injection molded transparent plastic

FIG. 3 is a front perspective of the diverter extension tube. Location 14 contains an integral locking ring that gets inserted into Location 12 in FIG. 2 to hold the diverter extension tube in place. Location 15 is an angle in the diverter extension tube of approximately 22.5 degrees to allow the operator to direct the airflow to the desired location. Location 16 is the air discharge point containing an integral bug deflector screen. The diverter extension tube will be constructed from injection molded transparent plastic

FIG. 4 is a top perspective of the hook and loop mounting straps. Location 17 shows the loop section of the mounting strap. Location 18 shows the hook section of the mounting strap.

FIG. 5 is a right perspective view.

FIG. 6 is a left perspective view.

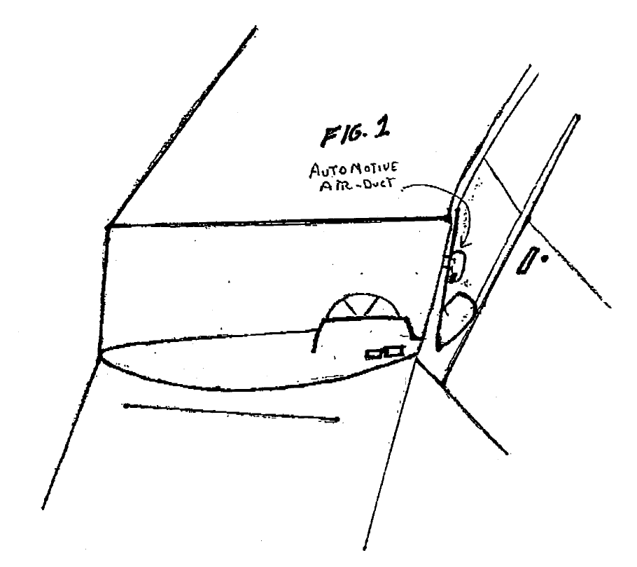

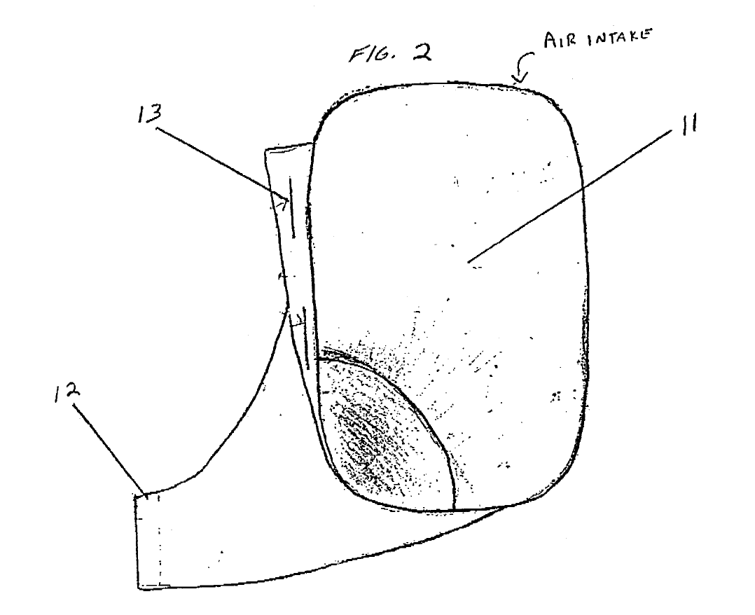

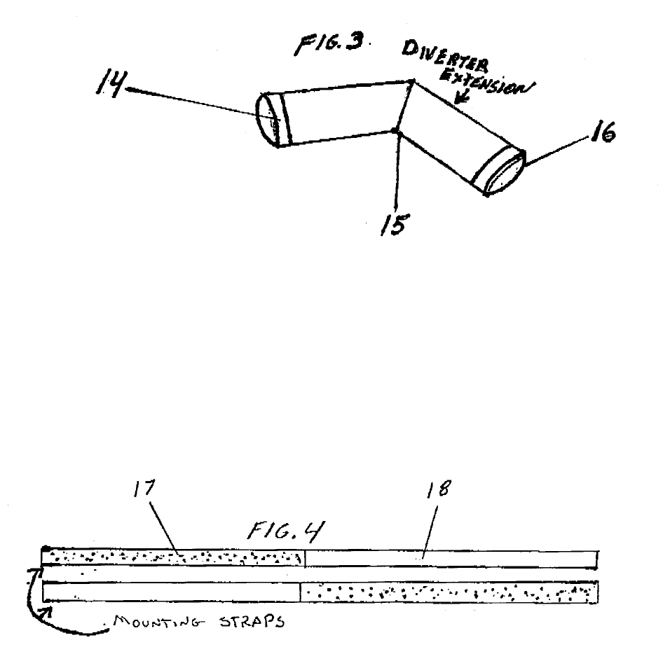

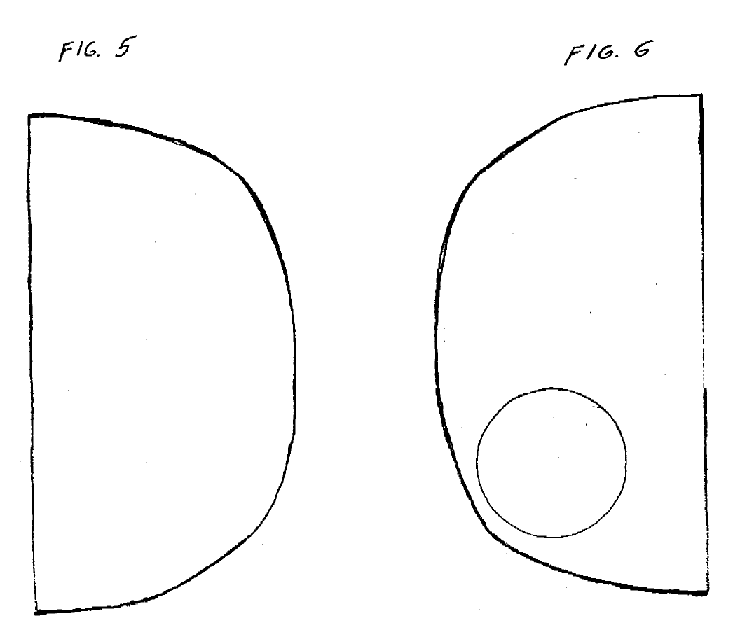

### DETAILED DESCRIPTION OF THE INVENTION

Automotive air duct a transparent plastic air-scooping device configured for the creation of additional airflow into the interior of an automobile. An air intake is fastened to the frame of an automobile door with the discharge point facing the inside of the automobile; a removable diverter extension is inserted into the air discharge point. The device is mounted on a framed automobile door with hook and loop straps. As the automobile is driven the air intake collects air and sends it through the diverter extension.

What is claimed is:

1. A portable air scooping or intake device for the compartment of an automotive vehicle comprising:
Portable removable air scooping device that can be mounted on any framed automotive vehicle door;
A removable diverter extension tube that may be inserted into the air discharge point of the air scoop;
Hook and loop straps for the temporary mounting on any framed automotive vehicle door;

2. The device as claimed in 1, wherein the device is portable.

3. The device as claimed in 1, wherein the device can be quickly mounted on any automotive vehicle door.
